(19) United States
(12) Patent Application Publication
(10) Pub. No.: US 2026/0135250 A1
(43) Pub. Date: May 14, 2026

(54) BATTERY PACK AND VEHICLE INCLUDING THE SAME

(71) Applicant: LG ENERGY SOLUTION, LTD., Daejeon (KR)

(72) Inventors: Shin-Young PARK, Daejeon (KR); Jong-Mo KANG, Daejeon (KR); Hyun-Soo KWON, Daejeon (KR); Yong-Hwan RO, Daejeon (KR); Sung-Won SEO, Daejeon (KR); Moon-Youl AHN, Daejeon (KR); Sang-Joon LEE, Daejeon (KR); Won-Mo HWANG, Daejeon (KR); Tae-Won HWANG, Daejeon (KR)

(21) Appl. No.: 19/318,111

(22) Filed: Sep. 3, 2025

(30) Foreign Application Priority Data
Nov. 14, 2024 (KR) 10-2024-0162457

(51) Int. Cl. H01M 50/383; B60L 50/64; H01M 50/211; H01M 50/249; H01M 50/358

(52) U.S. Cl. CPC H01M 50/383; B60L 50/64; H01M 50/211; H01M 50/249; H01M 50/358; H01M 2220/20

(57) ABSTRACT

A battery pack including a cell assembly including a plurality of battery cells; a bottom frame disposed on one side of the cell assembly, and provided with a first venting space exposed to the cell assembly, a second venting space communicating with the first venting space, and a third venting space communicating with the second venting space through at least one opening; and at least one flow guide member disposed in the second venting space, and configured to guide a flow direction of a venting gas discharged into the second venting space to a direction toward the opening.

### CROSS REFERENCES TO RELATED APPLICATIONS

This application is based on and claims priority from Korean Patent Application No. 10-2024-0162457, filed on Nov. 14, 2024, with the Korean Intellectual Property Office, the disclosure of which is incorporated herein in its entirety by reference.

### TECHNICAL FIELD

The present disclosure relates to a battery pack and a vehicle including the same.

### BACKGROUND

Secondary batteries, which are easily applicable to various product types and have a high energy density as electrical characteristics, are widely used not only in portable devices but also in electric vehicles (EV) and hybrid electric vehicles (HEV) that are powered by electric power sources. Secondary batteries offer the primary advantage of significantly reducing fossil fuel consumption, and furthermore, generate no by-products during the use of energy. Thus, secondary batteries are gaining attention as a new energy source for enhancing environmental sustainability and energy efficiency.

Presently, widely used types of secondary batteries include lithium-ion batteries, lithium-polymer batteries, nickel-cadmium batteries, nickel-hydrogen batteries, nickel-zinc batteries, and so on. In general, according to the shapes of exterior materials, lithium secondary batteries may be classified into can-type secondary batteries, in which an electrode assembly is mounted in a metal can, and pouch-type secondary batteries, in which an electrode assembly is mounted in a pouch of an aluminum laminate sheet.

When a high output voltage is required, multiple battery cells may be connected in series to form a battery module or a battery pack. For the purpose of increasing the charge/discharge capacity, multiple battery cells may be connected in parallel, thereby forming a battery module or a battery pack. The number of battery cells included in the battery module or pack may be variously set according to the required output voltage or charge/discharge capacity.

When multiple battery cells are connected in series/parallel to form a battery pack, it is common to first form a battery module including at least one battery cell, and then, form a battery pack or a battery rack by adding other components using the formed battery module. Recently, a cell-to-pack type battery pack has been manufactured, in which multiple battery cells are accommodated directly in a pack housing or the like without being modularized.

### SUMMARY

The present disclosure provides a battery pack capable of smooth venting upon the occurrence of a thermal event, and a vehicle including the same.

Further, the present disclosure provides a battery pack, in which a thermal propagation phenomenon may be effectively prevented or suppressed, and a vehicle including the same.

The objects sought to be achieved by the present disclosure are not limited to those described above, and other objects that are not described herein may clearly be understood by those skilled in the art from the descriptions of the invention herein below.

A battery pack according to the present disclosure includes: a cell assembly including a plurality of battery cells; a bottom frame disposed on one side of the cell assembly, and provided with a first venting space exposed to the cell assembly, a second venting space communicating with the first venting space, and a third venting space communicating with the second venting space through at least one opening; and at least one flow guide member that is disposed in the second venting space, and guides a flow direction of a venting gas discharged into the second venting space to a direction toward the opening.

The flow guide member may be disposed between the first venting space and the third venting space, in the second venting space.

The at least one flow guide member may be formed to be inclined toward the opening.

The flow guide member may be formed to be concave toward the first venting space.

The opening may include a first opening formed in one end of the third venting space and a second opening formed in an opposite end thereof, and the at least one flow guide members may be provided to be symmetrical with each other toward the first opening and the second opening.

In the cell assembly of the battery pack according to the present disclosure, the plurality of battery cells may be grouped in units of banks, and the flow guide member may be provided to correspond to each bank.

The flow guide member may be provided in a fin shape.

The battery pack according to the present disclosure may further include a partition that is disposed between any two of the adjacent flow guide members, and blocks a flow of a venting gas.

The opening may include a first opening formed in one end of the third venting space and a second opening formed in an opposite end thereof, and the partition is disposed in a position corresponding to a center position between the first opening and the second opening.

In the cell assembly of the battery pack according to the present disclosure, the plurality of battery cells may be arranged to be stacked, the first venting space may be elongated in a direction parallel to a stacking direction of the plurality of battery cells.

The bottom frame may include a routing frame disposed inside the second venting space, and making up the third venting space.

The bottom frame may further include an inner frame disposed on one side of the cell assembly, and an outer frame disposed on one side of the inner frame. The routing frame may be disposed between the inner frame and the outer frame, the first venting space may be formed between the cell assembly and the inner frame, and the second venting space may be formed between the inner frame and the outer frame.

The flow guide member may support the inner frame and the outer frame.

The flow guide member may be spaced apart from the routing frame.

The bottom frame may be disposed underneath the cell assembly.

The battery pack according to the present disclosure may further include a venting device that communicates the third venting space and an outside of the battery pack.

A vehicle according to the present disclosure includes at least one battery pack according to the present disclosure.

A bottom frame according to the present disclosure is disposed on one side of a cell assembly including a plurality of battery cells, and provided with a first venting space exposed to the cell assembly, a second venting space communicating with the first venting space, and a third venting space communicating with the second venting space through at least one opening. The bottom frame includes at least one flow guide member that is disposed in the second venting space, and guides a flow direction of a venting gas discharged into the second venting space to a direction toward the opening.

The flow guide member may be disposed between the first venting space and the third venting space, in the second venting space.

The at least one flow guide member may be formed to be inclined toward the opening.

According to the present disclosure, it is possible to provide a battery pack capable of smooth venting upon the occurrence of a thermal event, and a vehicle including the same.

According to an aspect of the present disclosure, it is possible to provide a battery pack, in which a thermal propagation phenomenon may be effectively prevented or suppressed, and a vehicle including the same.

According to an aspect of the present disclosure, it is possible to provide a battery pack, in which a flow path of a venting gas may be expanded, and a vehicle including the same.

According to an aspect of the present disclosure, it is possible to provide a battery pack, in which a backflow of the venting gas may be effectively prevented or suppressed, and a vehicle including the same.

According to an aspect of the present disclosure, it is possible to provide a battery pack, in which a flow of the venting gas may be reliably partitioned and guided, and a vehicle including the same.

According to an aspect of the present disclosure, it is possible to provide a battery pack, in which the flow of the venting gas may be uniformly distributed, and a vehicle including the same.

According to an aspect of the present disclosure, it is possible to provide a battery pack with an improved structural stability, and a vehicle including the same.

According to an aspect of the present disclosure, it is possible to provide a battery pack, in which the safety of an occupant may be ensured, and a vehicle including the same.

According to an aspect of the present disclosure, it is possible to provide a battery pack, in which the venting gas may be discharged smoothly to the outside of the battery pack, and a vehicle including the same.

The effects of the present disclosure are not limited to those described above, and effects that are not described herein may clearly be understood by those skilled in the art of the present disclosure from the descriptions herein below and the accompanying drawings.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a perspective view illustrating an overall appearance of a battery pack according to an embodiment of the present disclosure.

FIG. 2 is an exploded perspective view of the battery pack of FIG. 1.

FIG. 3 is a cross-sectional side view illustrating a portion of the AA′ cross section of FIG. 1.

FIG. 4 is a plan view illustrating a portion of the interior of the battery pack according to an embodiment of the present disclosure.

FIG. 5 is an enlarged plan view illustrating a portion of FIG. 4.

FIG. 6 is an enlarged cross-sectional perspective view illustrating a portion of a bottom frame according to an embodiment of the present disclosure.

FIG. 7 is an enlarged plan view illustrating a portion of the interior of the battery pack according to a modification of the present disclosure.

FIG. 8 is an enlarged plan view illustrating a portion of the interior of the battery pack according to another embodiment of the present disclosure.

FIG. 9 is a cross-sectional perspective view illustrating the bottom frame of the battery pack according to an embodiment of the present disclosure.

FIG. 10 is an exploded perspective view of the bottom frame of FIG. 9.

FIG. 11 is a perspective view illustrating a cell assembly of a battery pack according to an embodiment of the present disclosure.

FIG. 12 is a perspective view illustrating a state where a vent cover is disassembled from the cell assembly of the battery pack according to an embodiment of the present disclosure.

FIG. 13 is a view illustrating a vehicle according to an embodiment of the present disclosure.

In some of the drawings, corresponding components will be denoted with the same reference numerals. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to the accompanying drawings. Words and terms used in the detailed description and the claims herein should not be interpreted to be limited to their usual or dictionary meanings, but should be interpreted to have meanings and concepts that correspond to the technical idea of the present disclosure in compliance with the principle that inventors may appropriately define terms and concepts for the purpose of best describing the present disclosure.

Accordingly, it can be appreciated that the embodiments described herein and the configurations illustrated in the drawings are merely examples of the present disclosure, which do not exhaustively represent the technical idea of the present disclosure, and various equivalents and modifications may be made to substitute the present disclosure at the time of filing the present disclosure.

In the descriptions herein below, unless otherwise specified, the X-axis direction will be referred to as the front-rear direction, the Y-axis direction perpendicular to the X-axis direction will be referred to as the left-right direction, and the Z-axis direction perpendicular to the X-Y plane will be referred to as the up-down direction (vertical direction).

A battery pack including multiple battery cells therein may be vulnerable to a thermal chain reaction that may occur among battery cells or battery modules. For example, when a thermal event such as thermal runaway occurs in any one of the battery cells, the thermal event may propagate to the remaining battery cells or battery modules. When the thermal propagation is not properly suppressed, the thermal event occurring in the specific battery cell may cause a chain reaction in the remaining battery cells or battery modules, resulting in severe accidents such as explosion or fire.

The present disclosure provides a battery pack, in which smooth venting may be achieved, and the thermal propagation may be effectively prevented or suppressed, even when a thermal event occurs in a battery cell, and a vehicle including the same.

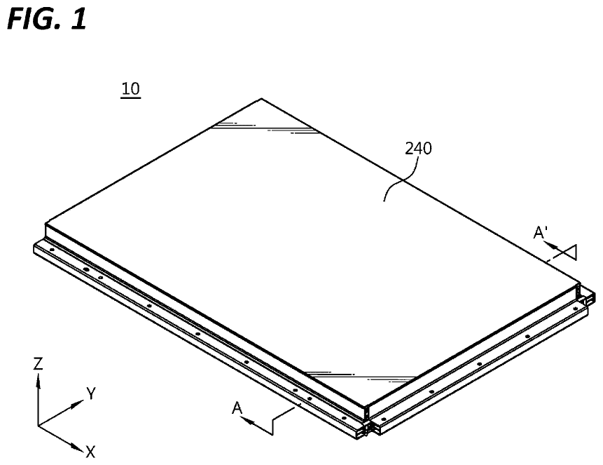

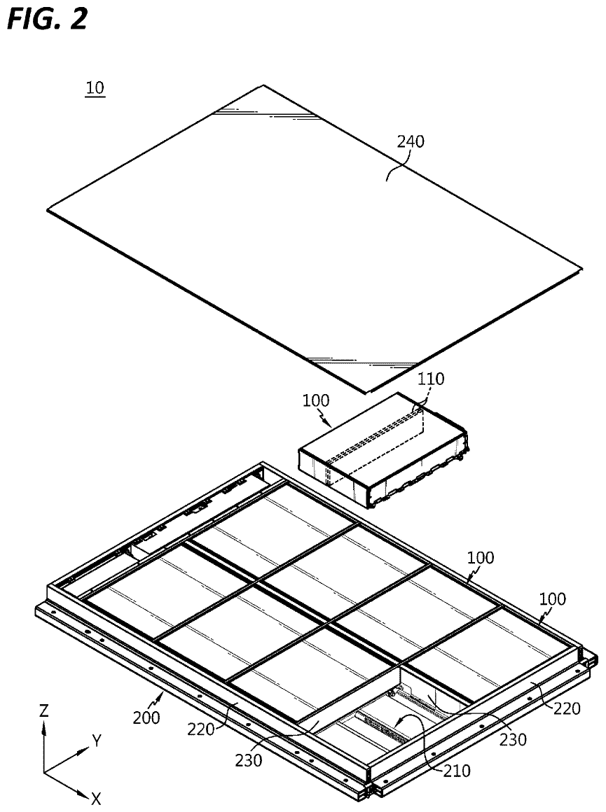

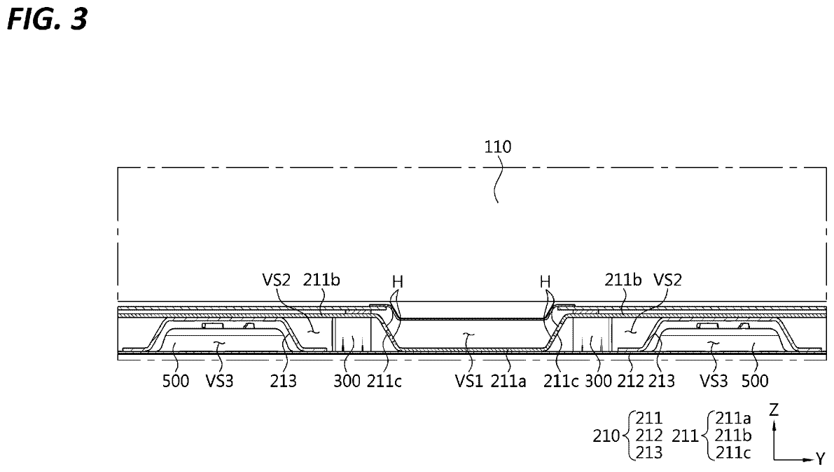

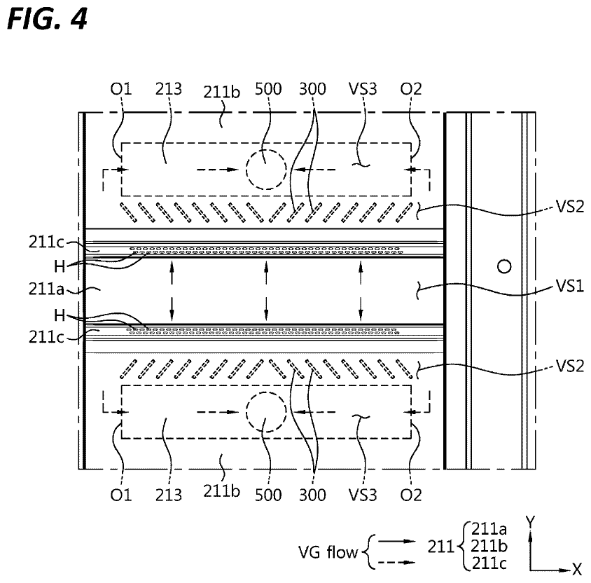

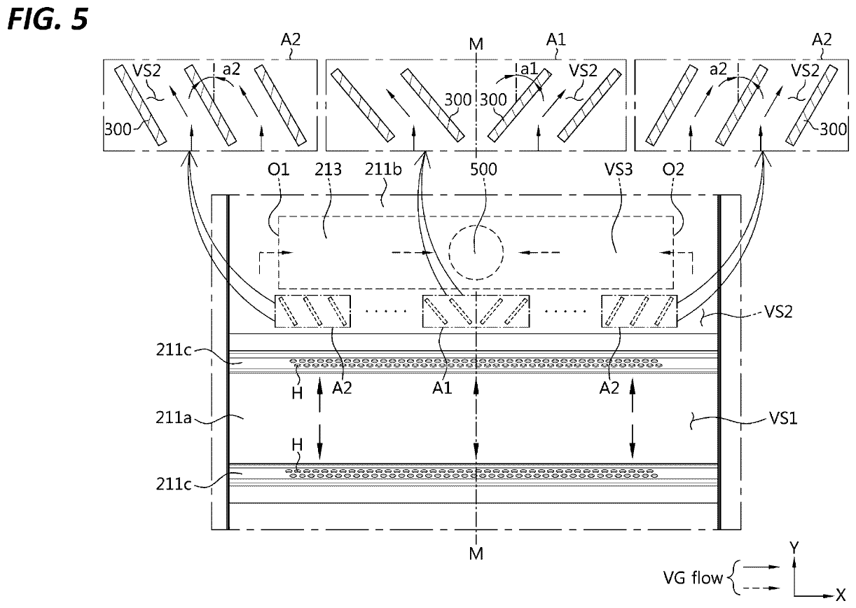

FIG. 1 is a perspective view illustrating an overall appearance of a battery pack 10 according to an embodiment of the present disclosure. FIG. 2 is an exploded perspective view of the battery pack 10 of FIG. 1. FIG. 3 is a cross-sectional side view illustrating a portion of the AA′ cross section of FIG. 1. FIG. 4 is a plan view illustrating a portion of the interior of the battery pack 10 according to an embodiment of the present disclosure. FIG. 5 is an enlarged plan view illustrating a portion of FIG. 4.

Hereinafter, with reference to FIGS. 1 to 5, the battery pack 10 according to an embodiment of the present disclosure will be described in detail. The battery pack 10 according to an embodiment of the present disclosure may include a cell assembly 100, a bottom frame 210, and a flow guide member 300.

Referring to FIGS. 1 and 2, the cell assembly 100 may include a plurality of battery cells 110. The cell assembly 100 may have predetermined width, length, and height in the X-axis direction, the Y-axis direction, and the Z-axis direction, respectively. In the cell assembly 100, the plurality of battery cells 110 may be arranged to be stacked. For example, the plurality of battery cells 110 may be stacked along the X-axis direction while standing upright along the Z-axis direction. When the plurality of battery cells 110 are arranged in this manner, the discharge direction of a venting gas VG to be described herein later may easily be controlled to a specific direction.

The battery pack 10 according to an embodiment of the present disclosure may include a plurality of cell assemblies 100.

Each battery cell 110 may be a secondary battery. The battery cell 110 may be, for example, a pouch-type battery cell 110. However, the battery cell 110 is not limited thereto, and may be a cylindrical or prismatic battery cell 110.

The bottom frame 210 may be disposed on one side of the cell assembly 100. For example, the bottom frame 210 may be disposed on one side of the cell assembly 100 in the Z-axis direction.

Referring to FIGS. 3 to 5, the bottom frame 210 may be provided with a first venting space VS1, a second venting space VS2, and a third venting space VS3.

When a thermal event occurs in any one or more battery cells 110 of the cell assembly 100, for example, a hot gas, flame, and solid ejecta may be emitted from the battery cells 110. The hot gas, flame, and solid ejecta may be collectively referred to as the venting gas VG.

The first venting space VS1 may be a space exposed to the cell assembly 100 such that the venting gas VG emitted from the cell assembly 100 may flow through the space.

The second venting space VS2 may communicate with the first venting space VS1. The second venting space VS2 may be a space through which the venting gas VG discharged from the first venting space VS1 may flow.

The third venting space VS3 may communicate with the second venting space VS2. The third venting space VS3 may be a space through which the venting gas VG discharged from the second venting space VS2 may flow. The second venting space VS2 and the third venting space VS3 may communicate with each other through at least one opening O1 or O2. The opening O1 or O2 may be understood as an opening formed in at least one end of the third venting space VS3 toward the second venting space VS2.

The third venting space VS3 may be provided, for example, inside the second venting space VS2. As illustrated in FIG. 4, for example, the third venting space VS3 may be provided in a substantially central region of the second venting space VS2 when viewed from the Z-axis direction.

The venting gas VG emitted from any one or more battery cells 110 of the cell assembly 100 into the first venting space VS1 may flow into the third venting space VS3 through the second venting space VS2.

The flow guide member 300 may be disposed in the second venting space VS2. The flow guide member 300 may be disposed inside the second venting space VS2.

The flow guide member 300 may be configured to guide the flow direction of the venting gas VG discharged into the second venting space VS2 to a specific direction. For example, the flow guide member 300 may be configured to guide the flow direction of the venting gas VG discharged from the first venting space VS1 into the second venting space VS2 to the direction toward the openings O1 and O2 of the third venting space VS3.

One or more flow guide members 300 may be provided. A plurality of flow guide members 300 may be provided.

As described herein later, the openings O1 and O2 may be formed in one end and the opposite end of the third venting space VS3, respectively. In this case, the flow guide member 300 may be configured to guide the flow direction of the venting gas VG discharged into the second venting space VS2 to both directions toward the openings O1 and O2, respectively.

In the battery pack 10 according to an embodiment of the present disclosure, the first venting space VS1, the second venting space VS2, and the third venting space VS3 are provided, so that the flow path of the venting gas VG may be effectively expanded. As a result, during the flow of the venting gas VG, the flow energy of the venting gas VG may decrease quickly and smoothly, and particles such as ash or by-products may be removed earlier.

Further, the battery pack 10 according to an embodiment of the present disclosure includes the flow guide member 300 configured as described above, so that the venting gas VG discharged from the first venting space VS1 into the second venting space VS2 may be quickly and smoothly guided to the third venting space VS3. When the flow direction of the venting gas VG is guided as described above, the backflow of the venting gas VG from the second venting space VS2 into the first venting space VS1 may be effectively prevented or suppressed. In the battery pack 10 according to an embodiment of the present disclosure, when a thermal event occurs in any one or more battery cells 110 of the cell assembly 100, the venting may be performed smoothly, and the thermal propagation phenomenon may also be effectively prevented or suppressed.

Meanwhile, the bottom frame 210 may include at least one communication hole H. The first venting space VS1 and the second venting space VS2 may communicate with each other through the communication hole H.

Referring to FIGS. 3 to 5, the flow guide member 300 may be disposed between the first venting space VS1 and the third venting space VS3, in the second venting space VS2. For example, as illustrated in FIG. 4, the flow guide member 300 may be disposed in a portion of the second venting space VS2 that is located between the first venting space VS1 and the third venting space VS3 in the Y-axis direction.

In this case, the flow guide member 300 is disposed close to the first venting space VS1, so that the flow of the venting gas VG discharged from the first venting space VS1 into the second venting space VS2 may be guided more directly.

Referring to FIGS. 3 to 5, at least one flow guide member 300 may be formed to be inclined toward the openings O1 and O2. When a plurality of flow guide members 300 is provided, a portion or all of the plurality of flow guide members 300 may be formed to be inclined toward the openings O1 and O2.

At least one flow guide member 300 may be formed to be inclined at a predetermined inclination angle.

Here, the inclination angle may be understood as the smaller angle of the angles between the direction from the first venting space VS1 toward the second venting space VS2 and an imaginary line segment connecting both ends of the flow guide member 300 (e.g., an imaginary line segment connecting one end of the flow guide member 300 close to the first venting space VS1 and the other end thereof apart from the first venting space VS1), when viewing the bottom frame 210 from the cell assembly 100. For example, as illustrated in FIG. 5, when viewed from the Z-axis direction, the second venting space VS2 is provided on the side of the first venting space VS1 in the Y-axis direction, and the inclination angle may be understood as the acute angle of the angles formed between the Y axis and the imaginary line segment connecting both ends of the flow guide member 300.

In this way, when at least one flow guide member 300 is formed to be inclined toward the openings O1 and O2, the venting gas VG discharged from the first venting space VS1 into the second venting space VS2 may be more quickly and smoothly guided to the third venting space VS3, and the backflow of the venting gas VG from the second venting space VS2 into the first venting space VS1 may be more effectively prevented or suppressed.

Of the areas where the flow guide members 300 are arranged, an area relatively apart from the openings O1 and O2 of the third venting space VS3 may be referred to as a first area A1, and an area relatively close to the openings O1 and O2 of the third venting space VS3 may be referred to as a second area A2.

In this case, at least one of the flow guide members 300 arranged in the first area A1 may be formed to be inclined, for example, at an inclination angle of a first angle a1 toward the closer of the openings O1 and O2. Further, at least one of the flow guide members 300 arranged in the second area A2 may be formed to be inclined, for example, at an inclination angle of a second angle a2 toward the closer of the openings O1 and O2.

The first angle a1 may be formed to be larger than the second angle a2. The inclination angle of each flow guide member H may gradually decrease from the first area A1 toward the second area A2.

Referring to FIGS. 4 and 5, the openings O1 and O2 may include a first opening O1 and a second opening O2, and the flow guide members 300 may be provided to be symmetrical with each other.

For example, the openings O1 and O2 may include the first opening O1 formed in one end of the third venting space VS3 and the second opening O2 formed in the opposite end of the third venting space VS3. For example, based on the drawings, the first opening O1 may be formed in the end of the third venting space VS3 on the side of the −X direction, and the second opening O2 may be formed in the end of the third venting space VS3 on the side of the +X direction.

Then, the flow guide members 300 may be provided to be symmetrical with each other toward the first opening O1 and the second opening O2. For example, the plurality of flow guide members 300 may be arranged or formed to be symmetrical with each other toward the first opening O1 and the second opening O2. The plurality of flow guide members 300 may be provided to be symmetrical with each other in the X-axis direction with respect to, for example, a center line M to be described herein later.

FIG. 5 illustrates the center line M for the convenience of description. The center line M may be understood as an imaginary line passing through the center between the first opening O1 and the second opening O2. For example, the center line M may be understood as an imaginary line passing through the center between the first opening O1 and the second opening O2 in the X-axis direction and extending parallel to the Y-axis direction. The center line M may pass through the first area A1 described above. The second area A2 described above may be areas spaced apart from the first area A1 in the −X direction and the +X direction.

When the openings O1 and O2 include the first opening O1 and the second opening O2 as described above, the third venting space VS3 may communicate with the second venting space VS2 at both sides thereof, so that the venting gas VG flowing in the second venting space VS2 may be more smoothly discharged into the third venting space VS3. Further, when the flow guide members 300 are provided to be symmetrical with each other toward the first opening O1 and the second opening O2 as described above, the flow of the venting gas VG discharged from the first venting space VS1 into the second venting space VS2 may be uniformly distributed to the first opening O1 and the second opening O2 of the third venting space VS3.

The flow guide members 300 may be provided to correspond to each bank of the battery cells 110. In the cell assembly 100, the plurality of battery cells 110 may be grouped in units of banks. For example, the plurality of battery cells 110 may be grouped into a bank including one battery cell 110 or two or more battery cells 110. A plurality of flow guide members 300 may be provided to correspond to each bank.

When the flow guide members 300 are provided as described above, the venting gas VG may be discharged smoothly for each bank, and the backflow of the venting gas VG from one bank to another bank may be effectively prevented or suppressed, so that the phenomenon of thermal propagation among banks may be effectively prevented or suppressed.

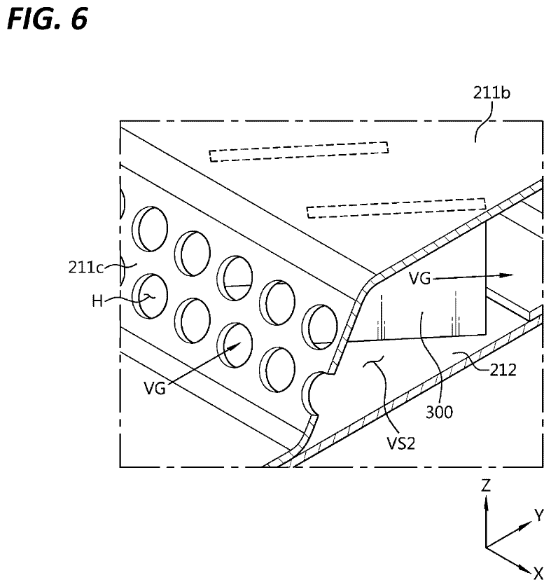

FIG. 6 is an enlarged cross-sectional perspective view illustrating a portion of a bottom frame according to an embodiment of the present disclosure.

Referring to FIG. 6, each flow guide member 300 may be provided in a fin shape. For example, the flow guide member 300 may be provided in the form of a wing that has a height in the Z-axis direction and extends to have a predetermined width in the direction perpendicular to the Z-axis.

When the flow guide member 300 is provided in the fin shape as described above, the flow of the venting gas VG may be reliably partitioned and guided.

The flow guide member 300 may be formed in any of the components of the bottom frame 210.

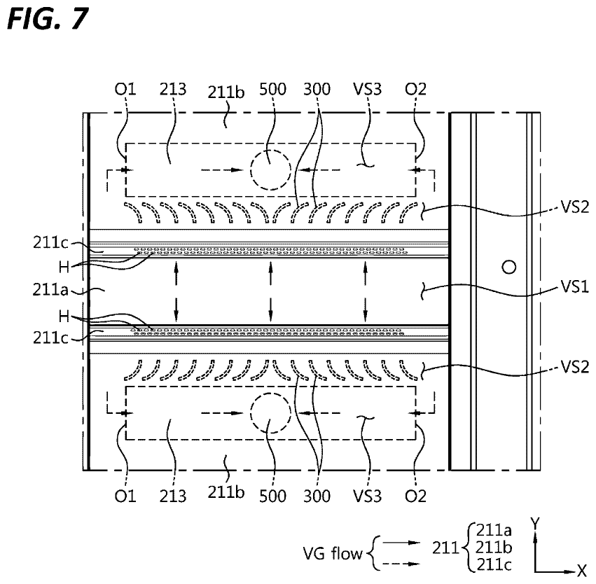

FIG. 7 is an enlarged plan view illustrating a portion of the interior of a battery pack 10 according to a modification of the present disclosure.

Hereinafter, with reference to FIG. 7, the battery pack 10 according to a modification of the present disclosure will be described in detail.

The flow guide member 300 of the battery pack 10 according to a modification of the present disclosure may be formed to be concave toward the first venting space VS1. In this case, the flow guide member 300 may be formed to be inclined at a predetermined inclination angle toward the openings O1 and O2 as described above.

When the flow guide member 300 is configured as described above, the venting gas VG discharged from the first venting space VS1 into the second venting space VS2 may more smoothly flow to the side of the flow guide member 300.

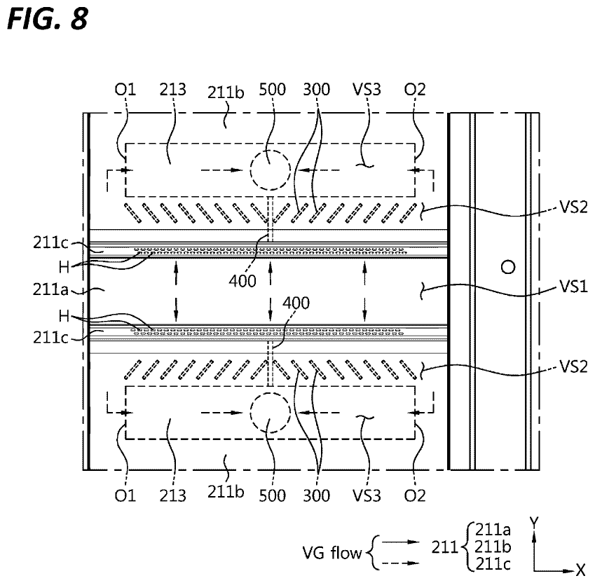

FIG. 8 is an enlarged plan view illustrating a portion of the interior of a battery pack 10 according to another embodiment of the present disclosure.

Hereinafter, with reference to FIG. 8, the battery pack 10 according to another embodiment of the present disclosure will be described in detail.

The battery pack 10 according to another embodiment of the present disclosure may further include a partition member 400. A plurality of flow guide members 300 may be provided, and the partition member 400 may be disposed between any two adjacent flow guide members 300. For example, as illustrated in FIG. 8, the partition member 400 may be disposed substantially at the center of the second venting space VS2 between the first venting space VS1 and the third venting space VS3.

The partition member 400 may be configured to block the flow of the venting gas VG. For example, the partition member 400 may be configured in a partition wall shape that may block the flow of the venting gas VG from one side thereof into the other side. For example, as illustrated in FIG. 8, the partition member 400 may be configured in the form of a partition wall extending in the Y-axis direction and the Z-axis direction to block the flow of the venting gas VG in the X-axis direction.

In this way, when the battery pack 10 further includes the partition member 400, the venting gas VG discharged into the second venting space VS2 may be reliably partitioned and distributed to both sides by the partition member 400.

The partition member 400 may be disposed at a position corresponding to the center between the first opening O1 and the second opening O2 described above. For example, as illustrated in FIG. 8, the first opening O1 and the second opening O2 are provided on the side of the third venting space VS3 in the −X direction and the side of the third venting space VS3 in the +X direction, respectively, and the partition member 400 may be disposed on the center line M.

When the partition member 400 is configured as described above, the flow of the venting gas VG discharged from the first venting space VS1 into the second venting space VS2 may be uniformly distributed to the first opening O1 and the second opening O2 of the third venting space VS3.

Referring back to FIGS. 2 and 4, the first venting space VS1 may be elongated. For example, the first venting space VS1 may be elongated in the direction parallel to the stacking direction of the plurality of battery cells 110.

For example, when the stacking direction of the plurality of battery cells 110 is the X-axis direction, the first venting space VS1 may be formed to be elongated in the X-axis direction. The first venting space VS1 may be elongated to or beyond the battery cells 110 disposed at both outermost sides of the cell assembly 100.

When the first venting space VS1 is elongated as described above, all the plurality of battery cells 110 may correspond to the single first venting space VS1.

Meanwhile, in the battery pack 10, a plurality of cell assemblies 100 may be arranged in a stacking manner, and the first venting space VS1 may be further elongated in the direction parallel to the stacking direction of the plurality of cell assemblies 100. In this case, the plurality of cell assemblies 100 may correspond to the single first venting space VS1.

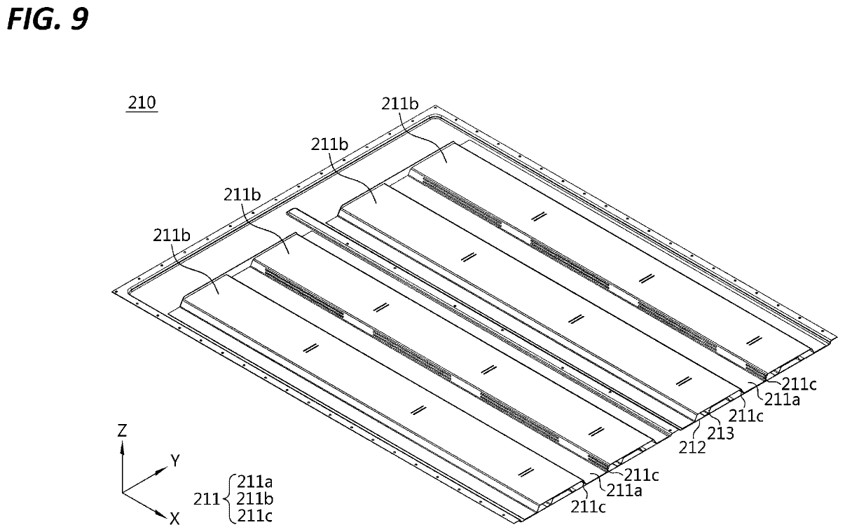

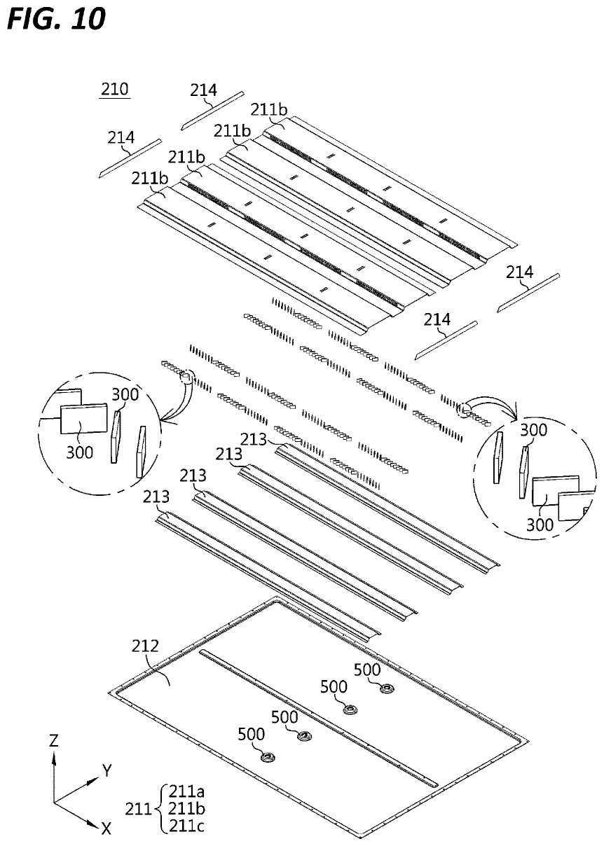

FIG. 9 is a cross-sectional perspective view illustrating the bottom frame 210 of the battery pack 10 according to an embodiment of the present disclosure, and FIG. 10 is an exploded perspective view illustrating the bottom frame 210 of FIG. 9.

Referring to FIGS. 3, 4, 9, and 10, the bottom frame 210 may include a routing frame 213. The routing frame 213 may be disposed inside the second venting space VS2. For example, when viewed from the Z-axis direction, the routing frame 213 may be disposed substantially at the center of the second venting space VS2.

The routing frame 213 may make up the third venting space VS3. The third venting space VS3 may be formed inside the routing frame 213.

When the bottom frame 210 is configured as described above, the third venting space VS3 may be easily and reliably formed in the bottom frame 210, and the second venting space VS2 and the third venting space VS3 may be reliably partitioned.

Meanwhile, the routing frame 213 may be provided in the form elongated in the X-axis direction. In this case, as illustrated in FIG. 4, the venting gas VG discharged from the first venting space VS1 into the second venting space VS2 may hit the routing frame 213 to be guided to the X-axis direction, and then, introduced into the third venting space VS3 through the openings O1 and O2.

A single routing frame 213 may be provided to correspond to only one cell assembly 100, or may be provided to correspond to a plurality of cell assemblies 100. For example, when the routing frame 213 is provided in the form illustrated in FIGS. 9 and 10, the single routing frame 213 may correspond to four cell assemblies 100. For the convenience of description, FIGS. 4, 5, 7, and 8 illustrate a single routing frame 213 as being provided corresponding to one cell assembly 100.

Referring to FIGS. 3, 4, 9, and 10, the bottom frame 210 may further include an inner frame 211 and an outer frame 212.

The inner frame 211 may be disposed on one side of the cell assembly 100. For example, the inner frame 211 may be disposed underneath the cell assembly 100.

The outer frame 212 may be disposed on one side of the inner frame 211. For example, the outer frame 212 may be disposed underneath the inner frame 211. The outer frame 212 may be disposed on the external side of the inner frame 211.

The routing frame 213 may be disposed between the inner frame 211 and the outer frame 212. For example, the outer frame 212, the routing frame 213, and the inner frame 211 may be disposed in this order in the upward direction.

The first venting space VS1 may be formed between the cell assembly 100 and the inner frame 211. For example, a portion of the inner frame 211 may be spaced apart downwardly from the cell assembly 100, and the first venting space VS1 may be formed in the gap formed by the vertical spacing.

The second venting space VS2 may be formed between the inner frame 211 and the outer frame 212. For example, the outer frame 212 may be spaced apart downwardly from another portion of the inner frame 211, and the second venting space VS2 may be formed in the gap formed by the vertical spacing.

When the bottom frame 210 is configured as described above, the first venting space VS1, the second venting space VS2, and the third venting space VS3 may be easily and distinctly formed in the bottom frame 210. Further, the rigidity of the bottom frame 210 may increase, so that the structural stability of the battery pack 10 may be enhanced.

Meanwhile, the routing frame 213 may be opened at the lower portion thereof, and the outer frame 212 may be disposed underneath the routing frame 213, such that the third venting space VS3 may be formed between the routing frame 213 and the outer frame 212.

Referring to FIGS. 6, 9, and 10, the flow guide members 300 may be configured to support the inner frame 211 and the outer frame 212.

The flow guide members 300 may be disposed between the inner frame 211 and the outer frame 212. Each flow guide member 300 may be configured to extend toward each of the inner frame 211 and the outer frame 212.

For example, the flow guide members 300 may be configured to support the inner frame 211 upwardly and support the outer frame 212 downwardly.

When the flow guide members 300 are configured in this manner, the rigidity of the bottom frame 210 may be enhanced, so that the structural stability of the battery pack 10 may be improved.

Referring to FIGS. 4, 9, and 10, the flow guide members 300 may be arranged to be spaced apart from the routing frame 213.

For example, the flow guide members 300 may be arranged to be spaced apart from the routing frame 213 in the direction toward the first venting space VS1.

When the flow guide members 300 are arranged in this manner, the venting gas VG discharged from the first venting space VS1 into the second venting space VS2 may be prevented or suppressed from being blocked by the routing frame 213 after passing through the flow guide members 300, so that the venting gas VG may flow more smoothly.

Referring back to FIGS. 2 and 3, the bottom frame 210 may be disposed underneath the cell assembly 100. In this case, the first venting space VS1 is provided underneath the cell assembly 100, so that the emission of the venting gas VG may be guided to the downward direction, and the battery pack 10 may be configured to have a bottom venting structure.

In a vehicle in which the battery pack 10 is mounted, an occupant such as a driver is generally positioned above the battery cells 110, and in a case where the venting gas VG is emitted upward from the battery cells 110 due to a thermal event, the safety of the occupant may be severely compromised. Thus, when the battery pack 10 is configured to have the bottom venting structure as in the present disclosure, the emission of the venting gas VG may be guided to the downward direction, which is opposite to the side of the occupant, so that the safety of the occupant may be ensured.

Referring back to FIGS. 3 and 4, the battery pack 10 according to the present disclosure may further include a venting device 500.

The venting device 500 may communicate the third venting space VS3 with the outside of the battery pack 10. The venting device 500 may be configured to discharge the venting gas VG flowing in the third venting space VS3 to the outside.

The venting device 500 may be disposed inside the third venting space VS3.

The venting device 500 may have a simple hole shape penetrating at least a portion of the bottom frame 210. The venting device 300 may be either provided in a fully open form, or configured to remain closed under normal conditions and open only in response to changes in pressure or temperature inside the third venting space VS3.

When the battery pack 10 further includes the venting device 500 as described above, there is an advantage in that the venting gas VG flowing in the third venting space VS3 may be smoothly discharged to the outside of the battery pack 10.

The venting device 500 may be provided in the outer frame 212 substantially at the center of the inside of the routing frame 213.

Meanwhile, the inner frame 211 may include a first bottom portion 211a, a second bottom portion 211b, and a side panel 211c.

The first venting space VS1 may be formed in the first bottom portion 211a. The first bottom portion 211a may be a portion of the inner frame 211 that is spaced apart downwardly from the cell assembly 100 to form the first venting space VS1. The first bottom portion 211a may be provided in a recessed shape toward the cell assembly 100. The first bottom portion 211a may be supported upwardly by the outer frame 212.

The second venting space VS2 may be formed in the second bottom portion 211b. The second bottom portion 211b may be another portion of the inner frame 211 that is spaced apart upwardly from the outer frame 212 to form the second venting space VS2. The second bottom portion 211b may be provided in a convex shape toward the cell assembly 100. The second bottom portion 211b may support the cell assembly 100 upwardly. The second bottom portion 211b may be supported upwardly by the routing frame 213.

The side panel 211c may be configured to connect the first bottom portion 211a and the second bottom portion 211b. The first bottom portion 211a and the second bottom portion 211b may be disposed at different heights. For example, based on the Z-axis direction, the first bottom portion 211a may be positioned lower than the second bottom portion 211b. The side panel 211c may be configured to connect the first bottom portion 211a and the second bottom portion 211b that are positioned at different heights. The side panel 211c may be provided with at least one communication hole H to communicate the first venting space VS1 and the second venting space VS2.

Meanwhile, the bottom frame 210 may further include a cover frame 214. The cover frame 214 may cover one end or both ends of the bottom frame 210. For example, the cover frame 214 may cover the ends of the second bottom portion 211b in the X-axis direction.

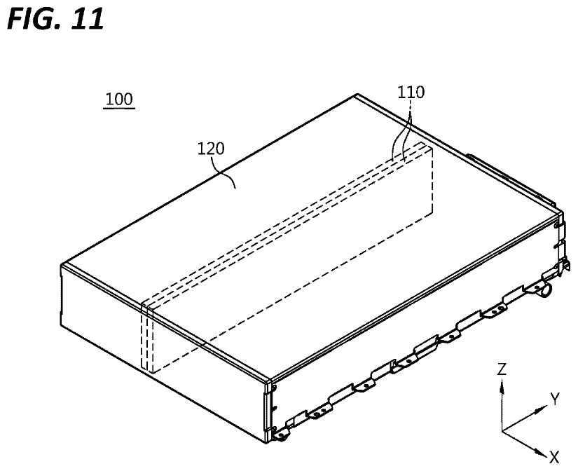

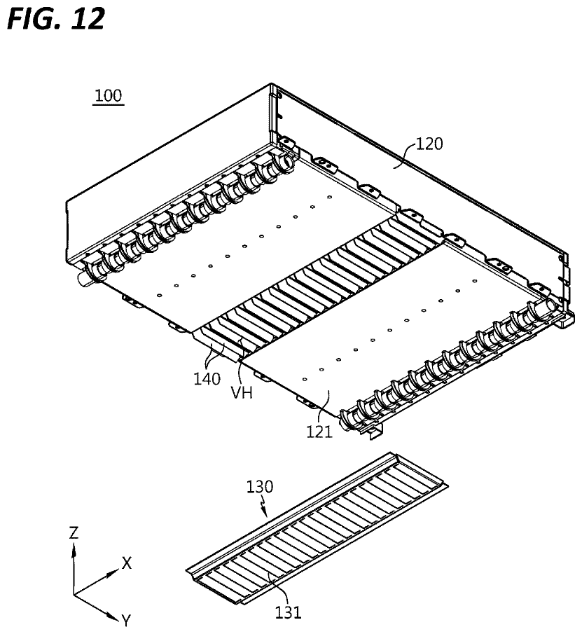

FIG. 11 is a perspective view illustrating a cell assembly of the battery pack according to an embodiment of the present disclosure, and FIG. 12 is a perspective view illustrating a state where the vent cover is disassembled from the cell assembly of the battery pack according to an embodiment of the present disclosure.

Meanwhile, as illustrated in FIGS. 11 and 12, the battery pack 10 according to an embodiment of the present disclosure may further include a module case 120 and the vent cover 130.

The module case 120 may accommodate the plurality of battery cells 110. The module case 120 may make up the overall external shape of the cell assembly 100. When the cell assembly 100 includes the module case 120, the cell assembly 100 may be configured as a battery module.

The module case 120 may be provided with a venting hole VH. The venting hole VH may be a hole opened toward the first venting space VS1. For example, the venting hole VH may be provided substantially at the center of the bottom 121 of the module case 120. The venting hole VH may be elongated along the stacking direction of the plurality of battery cells 110 (e.g., the X-axis direction).

The vent cover 130 may cover the venting hole VH. The vent cover 130 may be configured to open toward the first venting space VS1 when a pressure equal to or more than a predetermined pressure is generated. For example, the vent cover 130 may include an opening/closing unit 131 that is openable and closable. The opening/closing unit 131 may be provided in the form of, for example, slit-processed cut lines. The opening/closing unit 131 may be provided in the form that may rupture easily, through, for example, a notch processing or a slit processing in a dotted-line pattern. The opening/closing unit 131 may be provided to correspond to each battery cell 110 or each bank that is a group of the battery cells 110. By the vent cover 130, the venting gas VG passing through the venting hole VH from the cell assembly 100 may be effectively prevented or suppressed from flowing back to the cell assembly 100 through the venting hole VH.

The cell assembly 100 may include at least one partition member 140. The partition member 140 may be provided on the side portion of the battery cell 110. The partition member 140 may be provided as at least one of a cooling member capable of cooling the battery cells and a pad member capable of blocking heat or flame.

Referring back to FIGS. 1 and 2, the battery pack 10 according to the present disclosure may further include a sidewall frame 220, a partition frame 230, and a pack lid 240. The sidewall frame 220 may surround the bottom frame 210, and may form an accommodation space together with the bottom frame 210 to accommodate at least one cell assembly 100. The partition frame 230 may partition the accommodation space, and each of the plurality of cell assemblies 100 may be accommodated in each partitioned accommodation space. The pack lid 240 may be provided to cover the accommodation space, and may be provided to cover the upper portion of the accommodation space. The bottom frame 210, the sidewall frame 220, the partition frame 230, and the pack lid 240 may be collectively referred to as a pack case 200.

Although not illustrated, the battery pack 10 according to the present disclosure may further include various devices for controlling the charging and discharging of the battery cells 110, such as a battery management system (BMS), current sensors, and fuses.

Embodiments of the battery pack 10 according to the present disclosure have been described. The technical idea of the present disclosure is not limited to the embodiments, and may include any two or more combinations thereof.

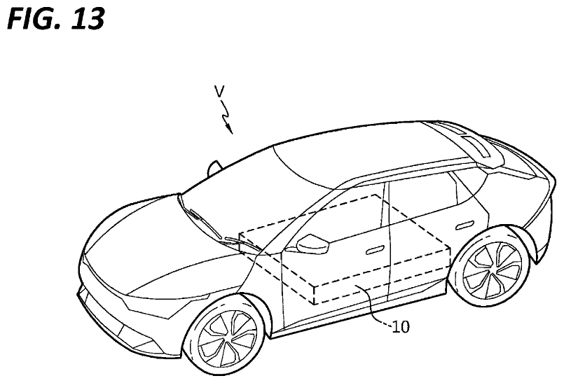

FIG. 13 is a view schematically illustrating a vehicle according to an embodiment of the present disclosure.

Referring to FIG. 13, the battery pack 10 according to the present disclosure may be applied to a vehicle V such as an electric vehicle or a hybrid vehicle. The vehicle V according to the present disclosure may include the battery pack 10 according to the present disclosure. The battery pack 10 may be provided in a vehicle body frame under a seat of the vehicle, or a trunk. The vehicle V according to an embodiment of the present disclosure may further include other various components included in vehicles, in addition to the battery pack 10. For example, the vehicle V according to an embodiment of the present disclosure may further include a vehicle body, a motor, and a control device such as an electronic control unit (ECU).

Further, the battery pack 10 according to an embodiment of the present disclosure may be provided not only in the vehicle V, but also in other devices, mechanisms, and equipment such as an energy storage system using secondary batteries.

While terms such as up, down, left, right, front, and rear have been used to indicate directions, it is obvious to those skilled in the art of the present disclosure that the terms are intended for the convenience of description, and may vary according to, for example, the location of an object to be viewed and the location of an observer.

While the present disclosure has been described with reference to the limited embodiments and drawings, the present disclosure is not limited thereto, and various modifications and changes may be made by those skilled in the art of the present disclosure within the technical idea of the present disclosure and the scope equivalent to the claims set forth below.

What is claimed is:

1. A battery pack comprising:
a cell assembly including a plurality of battery cells;
a bottom frame disposed on one side of the cell assembly, and provided with a first venting space exposed to the cell assembly, a second venting space communicating with the first venting space, and a third venting space communicating with the second venting space through at least one opening; and
at least one flow guide member disposed in the second venting space, and configured to guide a flow direction of a venting gas discharged into the second venting space to a direction toward the opening.

2. The battery pack according to claim 1, wherein the flow guide member is disposed between the first venting space and the third venting space, in the second venting space.

3. The battery pack according to claim 1, wherein the at least one flow guide member is formed to be inclined toward the opening.

4. The battery pack according to claim 3, wherein the flow guide member is formed to be concave toward the first venting space.

5. The battery pack according to claim 1, wherein the opening includes a first opening formed in one end of the third venting space and a second opening formed in an opposite end thereof, and
the at least one flow guide member is provided to be symmetrical with each other toward the first opening and the second opening.

6. The battery pack according to claim 1, wherein in the cell assembly, the plurality of battery cells are grouped in units of banks, and
the flow guide member is provided to correspond to each bank.

7. The battery pack according to claim 1, wherein the flow guide member is provided in a fin shape.

8. The battery pack according to claim 1, further comprising:
a partition disposed between any two of the adjacent flow guide members, and configured to block a flow of a venting gas.

9. The battery pack according to claim 8, wherein the opening includes a first opening formed in one end of the third venting space and a second opening formed in an opposite end thereof, and
the partition is disposed in a position corresponding to a center position between the first opening and the second opening.

10. The battery pack according to claim 1, wherein in the cell assembly, the plurality of battery cells are arranged to be stacked,
the first venting space is elongated in a direction parallel to a stacking direction of the plurality of battery cells.

11. The battery pack according to claim 1, wherein the bottom frame includes
a routing frame disposed inside the second venting space, and making up the third venting space.

12. The battery pack according to claim 11, wherein the bottom frame further includes
an inner frame disposed on one side of the cell assembly, and
an outer frame disposed on one side of the inner frame,
the routing frame is disposed between the inner frame and the outer frame,
the first venting space is formed between the cell assembly and the inner frame, and
the second venting space is formed between the inner frame and the outer frame.

13. The battery pack according to claim 12, wherein the flow guide member is configured to support the inner frame and the outer frame.

14. The battery pack according to claim 11, wherein the flow guide member is spaced apart from the routing frame.

15. The battery pack according to claim 1, wherein the bottom frame is disposed underneath the cell assembly.

16. The battery pack according to claim 1, further comprising:
a venting device configured to communicate the third venting space and an outside of the battery pack.

17. A vehicle comprising at least one battery pack according to claim 1.

18. A bottom frame disposed on one side of a cell assembly including a plurality of battery cells, and provided with a first venting space exposed to the cell assembly, a second venting space communicating with the first venting space, and a third venting space communicating with the second venting space through at least one opening,
wherein the bottom frame includes at least one flow guide member disposed in the second venting space, and configured to guide a flow direction of a venting gas discharged into the second venting space to a direction toward the opening.

19. The bottom frame according to claim 18, wherein the flow guide member is disposed between the first venting space and the third venting space, in the second venting space.

20. The bottom frame according to claim 18, wherein the at least one flow guide member is formed to be inclined toward the opening.
